(19) United States
(12) Patent Application Publication
(10) Pub. No.: US 2023/0076129 A1
(43) Pub. Date: Mar. 9, 2023

(54) SYSTEMS AND METHODS FOR PRESENTING A TOPIC TO BE LEARNED

(71) Applicant: Toyota Research Institute, Inc., Los Altos, CA (US)

(72) Inventors: Matthew Lee, Mountain View, CA (US); Shabnam Hakimi, Chape Hill, NC (US); Nikos Arechiga, San Mateo, CA (US); Charlene C. Wu, San Francisco, CA (US)

(73) Assignee: Toyota Research Institute, Inc., Los Altos, CA (US)

(21) Appl. No.: 17/470,719

(22) Filed: Sep. 9, 2021

(51) Int. Cl. G06N 5/02; G06N 20/00; G06F 16/9035; G06F 16/9038

(52) U.S. Cl. CPC G06N 5/022; G06N 20/00; G06F 16/9035; G06F 16/9038

(57) ABSTRACT

A system includes a processor configured to determine analogies between information associated with a new topic to be learned and information associated with existing knowledge of a user, identify terms associated with the new topic that appear similar to terms associated with the existing knowledge, and propose questions for the user to explore based on the new topic and the existing knowledge.

### TECHNICAL FIELD

The present specification generally relates to systems and methods that present a new topic to be learned to a user based on the new topic and existing knowledge of the user.

### BACKGROUND

Learning a new topic can often be a daunting task for individuals to undertake. When attempting to learn a new topic by his or herself, an individual may not know where to start. That is, the individual may not know which subtopic of the overall topic to be learned should be explored first. The individual may reference one or more curricula on the topic to be learned to guide the individual through the learning process. However, such curricula is generally linear in nature and is designed for a generic user assumed to have no existing knowledge on the topic. That is, such curricula is not individually tailored to the individual based on the individual's particular interests and existing knowledge in the topic or related topics. Many individuals may become frustrated with such linear curricula because the curricula does not adequately challenge or interest the individual. Therefore, many individuals may abandon their pursuit of learning the new topic from an inability to find a curriculum properly tailored to the individuals' interests and existing knowledge.

Accordingly, a need exists for systems that present a topic to be learned to a user based on the user's existing knowledge.

### SUMMARY

In one embodiment, a system includes a processor configured to determine analogies between information associated with a new topic to be learned and information associated with existing knowledge of a user, identify terms associated with the new topic that appear similar to terms associated with the existing knowledge, and propose questions for the user to explore based on the new topic and the existing knowledge.

In another embodiment, a method implemented by a processor of a device includes determining analogies between information associated with a new topic to be learned and information associated with existing knowledge of a user, identifying terms associated with the new topic that appear similar to terms associated with the existing knowledge, and proposing questions for the user to explore based on the new topic and the existing knowledge.

In yet another embodiment, a processor of a computing device is configured to determine analogies between information associated with a new topic to be learned and information associated with existing knowledge of a user, identify terms associated with the new topic that appear similar to terms associated with the existing knowledge, and propose questions for the user to explore based on the new topic and the existing knowledge.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example operating environment of the system for presenting a new topic to be learned of the present disclosure, according to one or more embodiments shown and described herein;

FIG. 2 schematically depicts non-limiting components of the devices of the system for presenting a new topic to be learned of the present disclosure, according to one or more embodiments shown and described herein;

FIG. 3 depicts a flowchart for presenting a new topic to be learned, according to one or more embodiments shown and described herein;

FIG. 4 schematically depicts an example interaction between a user and the system of FIG. 2 on a user device of the system of FIG. 2, according to one or more embodiments shown and described herein; and

FIG. 5 schematically depicts example proposed questions for the user to explore on a user device of the system of FIG. 2, according to one or more embodiments shown and described herein.

### DETAILED DESCRIPTION

Embodiments described herein are directed to systems and methods for presenting a new topic to be learned to a user based on the new topic and existing knowledge of the user. The system collects data on a user to build a model of the existing knowledge of the user. The system also collects data to determine a new topic to be learned by the user. The system may assemble domains of information related to the existing knowledge of the user and the new topic to be learned by the user to compare. By comparing the existing knowledge of the user with the new topic to be learned, the system may determine analogies between information associated with the new topic to be learned and information associated with the existing knowledge of the user. The analogies may be drawn between information associated with the new topic to be learned that is functionally similar to information associated with the existing knowledge of the user. The system may also identify terms associated with the new topic to be learned and terms associated with the existing knowledge of the user that appear similar but have different meanings. The system may then propose questions for the user to explore that relate to the new topic to be learned. The questions may relate to a critical concept shared by the new topic to be learned and the existing knowledge of the user. The questions may be based on the analogies drawn between the existing knowledge of the user and the new topic to be learned and/or the key terms of the existing knowledge of the user and the new topic to be learned that appear similar but have different meaning. The system may provide answers to the questions proposed, the answers providing information on the new topic to be learned. The answers may explain the new topic to be learned in light of the existing knowledge of the user, the analogies between the new topic to be learned and the existing knowledge of the user, and/or the identified key terms that appear similar but have different meanings. Various embodiments of the system for presenting a new topic to be learned to a user and operation of the system are described in more detail herein. Whenever possible, the same reference numerals will be used throughout the drawings to refer to the same or like parts.

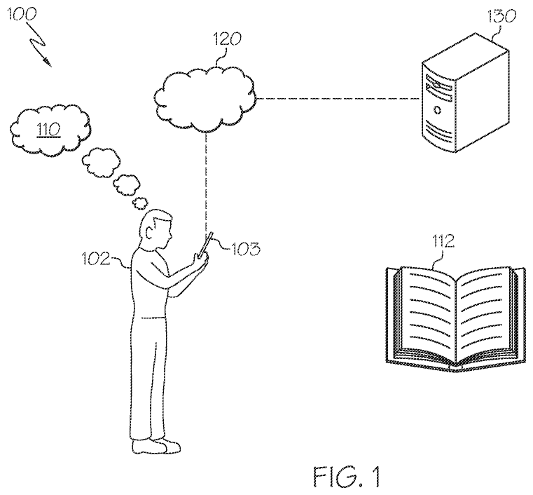

Referring now to the drawings, FIG. 1 schematically depicts an example operating environment of a system 100 for presenting a new topic to be learned of the present disclosure, according to one or more embodiments shown and described herein. As illustrated, FIG. 1 depicts a user 102 operating a user device 103. The user device 103 may be a personal electronic device of the user 102. The user device 103 may be used to perform one or more user-facing functions, such as receiving one or more inputs from the user 102 or providing information to the user 102. The user device 103 may be a cellular phone, tablet, or personal computer of the user 102. The user device 103 includes a processor for presenting a new topic to be learned 112 to the user 102 based on existing knowledge 110 of the user 102. Merely as an example, the new topic to be learned 112 may be a first programming language, and the existing knowledge 110 of the user 102 may include information associated with or related to a second programming language.

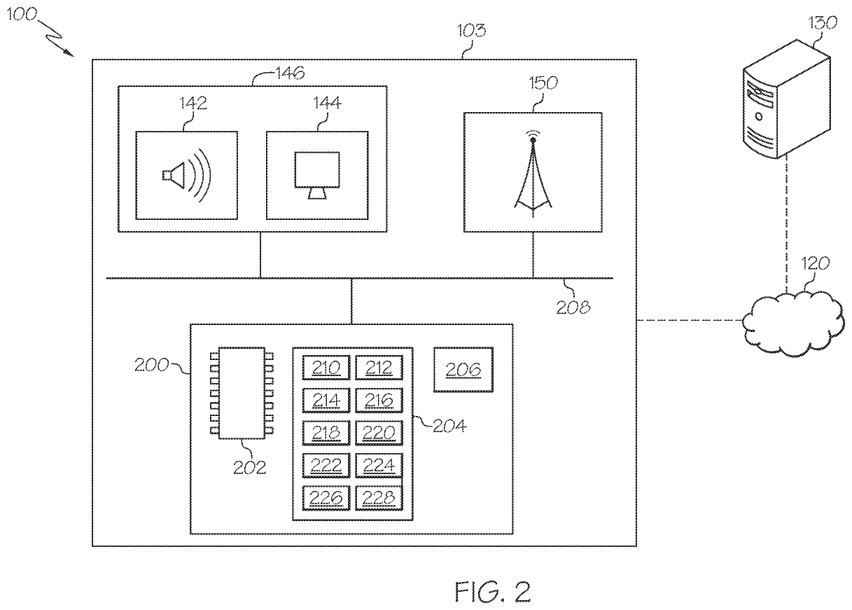

Referring now to FIG. 2, non-limiting components of the user device 103 of the system 100 for presenting a new topic to be learned of the present disclosure are schematically depicted, according to one or more embodiments shown and described herein. The user device 103 includes a controller 200 including a processor 202, a memory module 204, and a data storage component 206. The user device 103 may further include an interface module 146, a network interface hardware 150, and a communication path 208. It should be understood that the user device 103 of FIG. 2 is provided for illustrative purposes only, and that other user devices 103 comprising more, fewer, or different components may be utilized.

Referring now to FIGS. 1 and 2, the processor 202 may be any device capable of executing machine readable and executable instructions. Accordingly, the processor 202 may be a controller, an integrated circuit, a microchip, a computer, or any other computing device. The controller 200, including the processor 202, is coupled to the communication path 208 that provides signal interconnectivity between various modules of the user device 103. Accordingly, the communication path 208 may communicatively couple any number of processors 202 within the user device 103 with one another, and allow the modules coupled to the communication path 208 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 208 may be formed from any medium that is capable of transmitting a signal such as, for example, conductive wires, conductive traces, optical waveguides, or the like. In some embodiments, the communication path 208 may facilitate the transmission of wireless signals, such as WiFi, Bluetooth®, Near Field Communication (NFC) and the like. Moreover, the communication path 208 may be formed from a combination of mediums capable of transmitting signals. In one embodiment, the communication path 208 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The controller 200 of the user device 103 includes the memory module 204. The controller 200, including the memory module 204, is coupled to the communication path 208. The memory module 204 may comprise RAM, ROM, flash memories, hard drives, or any device capable of storing machine readable and executable instructions such that the machine readable and executable instructions can be accessed by the processor 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the memory module 204. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIGS. 1 and 2, the user device 103 comprises network interface hardware 150 for communicatively coupling the user device 103 to the external device 130. The network interface hardware 150 can be communicatively coupled to the communication path 208 and can be any device capable of transmitting and/or receiving data via a network. Accordingly, the network interface hardware 150 can include a communication transceiver for sending and/or receiving any wired or wireless communication. For example, the network interface hardware 150 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 150 includes hardware configured to operate in accordance with the Bluetooth® wireless communication protocol. The network interface hardware 150 of the user device 103 may transmit information on the new topic to be learned 112 and/or the existing knowledge 110 of the user 102 to the external device 130. The network interface hardware 150 may also receive information and data relating to the new topic to be learned 112 from the external device 130.

In some embodiments, the user device 103 may be communicatively coupled to the external device 130 by the network 120. In one embodiment, the network 120 may include one or more computer networks (e.g., a personal area network, a local area network, or a wide area network), cellular networks, satellite networks and/or a global positioning system and combinations thereof. Accordingly, the user device 103 can be communicatively coupled to the network 120 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

The external device 130 may be any database server or electronic device belonging to the user 102 or a third party. For instance, the external device 130 may contain one or more storage devices for storing data pertaining to the operation of the system 100 for presenting a new topic to be learned. The external device 130 may function as a general database for transmitting data relating to the new topic to be learned 112, as discussed in further detail below.

The user device 103 comprises the interface module 146. The interface module 146 may be coupled to the communication path 208. The interface module 146 includes one or more user/machine interfaces to allow presentation of data or information to the user 102 and/or allow for input of user information to the user device 103. For instance, the interface module 146 may include a visual interface 144. The visual interface 144 may be, for example, a cathode ray tube, light emitting diodes, a liquid crystal display, a plasma display, or the like. Moreover, the visual interface 144 may be a touchscreen that, in addition to providing an optical display, detects the presence and location of a tactile input upon a surface of or adjacent to the visual interface 144. The interface module 146 may also include audial interface 142. The audial interface 142 may include one or more speakers to output an audio message to the user 102. The audial interface 142 may also include a microphone to receive audio input, such as vocal commands, from the user 102.

Referring again to the memory module 204 of the controller 200 of the user device 103, the programming instructions stored in the memory module 204 may be embodied as a plurality of software logic modules, where each logic module provides programming instructions for completing one or more tasks. Each of the logic modules may be embodied as a computer program, firmware, or hardware, as an example. Illustrative examples of logic modules present in the memory module 204 include, but are not limited to, topic to be learned logic 210, existing knowledge logic 212, data receiving logic 214, analogy logic 216, term logic 218, communication logic 220, question logic 222, answer logic 224, testing logic 226, and training logic 228.

The topic to be learned logic 210 includes one or more programming instructions for determining or receiving the new topic to be learned 112 by the user 102. The new topic to be learned 112 may be any subject the user 102 wishes to learn. Merely as examples, the new topic to be learned 112 may be a programming language, a spoken language, a new instrument, a nation's history, or a new sport. It should be appreciated that any number of topics, beyond those listed, may be the new topic to be learned 112 by the user 102.

The topic to be learned logic 210 includes programming instructions for receiving input from the user 102 providing the new topic to be learned 112. For instance, the user 102 may provide the new topic to be learned 112 through the interface module 146. Merely as an example, the user 102 may speak or type the new topic to be learned 112 through the interface module 146. The user 102 may also provide a picture or video indicating the new topic to be learned 112. For instance, the user 102 may take a picture of a textbook on the programming language Python with the user device 103, indicating an interest in learning how to code in Python.

The topic to be learned logic 210 also includes programming instructions for predicting the new topic to be learned 112. For instance, the topic to be learned logic 210 may include programming to predict a topic the user 102 is interested in or wishes to learn based on user-specific data. The user-specific data may be stored in the data storage component 206 and derived from one or more applications associated with the user device 103, as discussed above. For instance, the controller 200 may receive information concerning the search history of the user 102 on the user device 103. Depending on the keyword searches completed by the user 102 and the web pages visited by the user 102, it can be predicted that the user 102 is trying to learn, or is interested in learning, a particular new topic to be learned 112. In addition to leveraging the search history of the user 102, the new topic to be learned 112 may be at least partially based on information derived from a personal email application of the user device 103, a personal calendar application of the user device 103, and the like. For instance, based on an electronic receipt indicating the user 102 purchased a guitar, it may be predicted that the user 102 wants to learn to play the guitar. As another example, if the user 102 has booked a vacation to Spain, it may be predicted that the user 102 may want to learn Spanish. One or more questions may then be posed to the user 102 to affirm the new topic to be learned 112 by the user 102, such as, “Do you wish to learn about Python?”

The existing knowledge logic 212 includes one or more programming instructions for building a model of the existing knowledge 110 of the user 102. In embodiments, a single model of the existing knowledge 110 of the user 102 may be built. That is, a comprehensive model of the existing knowledge 110 of the user 102 may be built, maintained, and updated. For instance, the model of the existing knowledge 110 of the user 102 may include information related to the user's expertise in one or more programming languages, fluency in a spoken language, and ability to play an instrument. In embodiments, separate models of the existing knowledge 110 of the user 102 may be built based on the new topic to be learned 112. For instance, if the new topic to be learned 112 is the programming language Python, a first model of the existing knowledge 110 of the user 102 may be built based on the expertise of the user 102 in a first programming language, such as C++. Additionally, if the new topic to be learned 112 is the Spanish language, a second model of the existing knowledge of the user 102 may be built based on the fluency of the user 102 in English. That is, separate models of the existing knowledge 110 of the user 102 may be built, maintained, and updated for different overarching subjects, such as programming, spoken language, musicianship, and the like.

The model of the existing knowledge 110 of the user 102 may be built by analyzing content consumed or authored by the user 102. Content consumed by the user 102 may relate to web pages visited on the user device 103, books purchased and/or downloaded and read by the user 102, tutorials watched by the user 102, conventions or presentations attended by the user 102, and the like. For instance, content consumed by the user 102 used to build a model of the existing knowledge 110 of the user 102 in the overarching subject of programming may include an e-book on the programming language C++ purchased and read by the user 102 on the user device 103. Content created by the user 102 may relate to any form of authorship of the user 102. As an example, content created by the user 102 may include programs coded in C++ and stored on the user device 103, written documents or essays on specific topics, such as a particular nation's history, recordings of the user 102 playing an instrument, and the like.

The model of the existing knowledge 110 of the user 102 may be built by quizzing the user 102 on critical concepts of the new topic to be learned 112. The critical concepts of the new topic to be learned 112 may relate to the overarching subject that includes the new topic to be learned 112. For example, if the new topic to be learned 112 is the programming language Python, the critical concepts may relate to the overarching subject of programming. More specifically, the critical concepts may relate to fundamental principles of programming, such as loops, declaring variables, if statements, and the like. Therefore, the system 100 may quiz the user 102 by posing a question to the user 102, such as, “Are you familiar with the function and use of for loops?” The critical concepts of the new topic to be learned 112 may also relate specifically to the new topic to be learned 112. For example, if the new topic to be learned 112 is the programming language Python, the critical concepts may relate to the implementation of fundamental principles of programming in Python, specifically. Therefore, the system 100 may quiz the user 102 by posing a question to the user 102, such as, “Do you know how to write for loops in Python?”

The user 102 may be quizzed on the critical concepts of the new topic to be learned 112 in any suitable format. For instance, the user 102 may be presented with multiple choice questions, matching questions, true/false questions, and/or short answer questions. For example, the user 102 may be asked to write a program in C++, or other programming language the user 102 already has experience in, to determine the proficiency of the user 102 in that specific programming language and/or to determine the knowledge of the user 102 with respect to fundamental programming principles, such as for loops and while loops. The user 102 may also be asked to write a program in Python, the new topic to be learned 112, to determine if the user 102 has any pre-existing knowledge or experience in the new topic to be learned 112.

The model of the existing knowledge 110 of the user 102 may also be built and/or updated based on previous interactions of the user 102 with the system 100, as will be discussed in greater detail below. It should be appreciated that the model of the existing knowledge 110 of the user 102 may be built based on any or all of content consumed or authored by the user 102, quizzing the user 102 about critical concepts of the new topic to be learned 112, and previous interactions of the user 102 with the system 100.

The data receiving logic 214 includes one or more programming instructions for receiving data from the external device 130. That is, the data receiving logic 214 includes programming to cause a connection between the network interface hardware 150 and the external device 130 such that data transmitted by the external device 130 is received by the controller 200. Further, the data transmitted by the external device 130 may be stored (e.g., within the data storage component 206). The data transmitted by the external device 130 may relate to the new topic to be learned 112. For instance, the network interface hardware 150 may communicate the new topic to be learned 112 that is determined with the topic to be learned logic 210 to the external device 130, soliciting data from the external device 130 relating to the new topic to be learned 112. For example, if the new topic to be learned 112 is the programming language Python, the external device 130 may transmit data to the controller 200 including coding manuals, textbooks, application programming interfaces, and the like related to Python. This data, collectively, may be stored as a first domain of information associated with the new topic to be learned 112.

The data transmitted by the external device 130 may also relate to the existing knowledge 110 of the user 102. For instance, the network interface hardware 150 may communicate the model of the existing knowledge 110 determined with the existing knowledge logic 212 to the external device 130, soliciting data from the external device 130 relating to the existing knowledge 110 of the user 102. For example, if the existing knowledge 110 of the user 102 relates to the programming language C++, the external device 130 may transmit data to the controller 200 including coding manuals, textbooks, application programming interfaces, and the like related to C++. This data, collectively, may be stored as a second domain of information associated with the existing knowledge 110 of the user 102. The domain of information associated with the existing knowledge 110 of the user 102 may be limited by the model of the existing knowledge of the user 102. For instance, the user 102 may be proficient in C++, but not an expert. Accordingly, the domain of information associated with the existing knowledge 110 of the user 102 may only include information on sub-topics of C++ that the user 102 has knowledge in instead of the entire universe of information on C++.

The analogy logic 216 includes one or more programming instructions for generating analogies between information associated with the new topic to be learned 112 and information associated with the existing knowledge 110 of the user 102. More particularly, the analogy logic 216 includes one or more programming instructions for generating analogies between information associated with the new topic to be learned 112 that is functionally similar to information associated with the existing knowledge 110 of the user 102. For instance, the new topic to be learned 112 may be the programming language Python, and the existing knowledge 110 of the user 102 may relate to the programming language C++. In the overall field of programming, a “for loop” refers to a control statement that allows code to be executed for a specified iteration. In C++, such a loop may, indeed, be referred to as a “for loop.” However, in Python, a loop with similar functionality, may be referred to under a different name. Despite the potential difference in naming convention between the two loops in C++ and Python, by executing relationship extraction or other forms of natural language processing between the domain of information associated with the new topic to be learned 112, Python, and the domain of information associated with the existing knowledge 110 of the user 102, C++, a functionally similar analogy may be identified between a “for loop” in C++ and a loop having a different name but the same function or implementation in Python. As another example, the new topic to be learned 112 may be the history of Slovenia, and the existing knowledge 110 of the user 102 may relate to the history of the United States. Despite differences in title, a functionally similar relationship between the American Revolutionary War and the Ten-Day War, as wars of independence for the United States and Slovenia, respectively, may be identified.

While in the above examples, analogies are generated between information associated with the new topic to be learned 112 that is functionally similar to information associated with the existing knowledge 110 of the user 102 despite differences in naming or wording of the information, this is merely an example of the operation of the analogy logic 216. That is, it should be appreciated that the analogy logic 216 may also enable analogies to be determined between information associated with the new topic to be learned 112 and information associated with the existing knowledge 110 of the user 102 that is both functionally similar and similar in naming or wording. For instance, if the new topic to be learned 112 is Python, and the existing knowledge 110 of the user 102 relates to C++, an analogy may be determined between “while loops” in C++ and “while loops” in Python, which on their surface appear to be related sub-topics C++ and Python, and are functionally related in their operation within C++ and Python.

The analogies determined between the new topic to be learned 112 and the existing knowledge 110 of the user 102 enable the existing knowledge 110 of the user 102 to be used to build informational bridges to the new topic to be learned 112, as will be described in greater detail below. Generally, however, if a first loop statement in Python is determined to be similar in function to a second loop statement in C++, the first loop statement in Python can be presented to the user 102 in light of the knowledge of the user 102 on the second loop statement in C++. This may make it easier for the user 102 to learn the first loop statement in Python than would otherwise be possible.

The term logic 218 includes one or more programming instructions for identifying terms associated with the new topic to be learned 112 that appear similar to terms associated with the existing knowledge 110 of the user 102. For instance, using entity extraction, or other language processing techniques, key terms in the domain of information related to the new topic to be learned 112 and the domain of information related to the existing knowledge 110 of the user 102 may be identified. The key terms may then be compared across the domain of information related to the new topic to be learned 112 and the domain of information related to the existing knowledge 110 of the user 102 to identify key terms across the domains that are verbatim matches (i.e., the same key term is found in both domains). Stemming may also be performed on the key terms in the domain of information related to the new topic to be learned 112 and the key terms in the domain of information related to the existing knowledge 110 of the user 102. The base or root form of the key terms across the domains may then be compared to identify key terms across the domains that match in their base or root form, although may not be verbatim matches.

The term logic 218 also includes one or more programming instructions for determining the definitions of the matching key terms within their respective domains and comparing the definitions of the matching key terms. In doing so, key terms in the domain of information related to the new topic to be learned 112 that appear similar to key terms in the domain of information related to the existing knowledge 110 of the user 102, but in fact, have different meanings or uses, may be determined. Therefore, the controller 200 may identify “false friends” between the domains. Merely as an example, if the new topic to be learned 112 by the user 102 is the Spanish language, and the existing knowledge 110 of the user 102 relates to the English language, the controller 200 may identify the word advertisement in English and the word advertencia in Spanish, which, in fact, translates to “warning” in English, as false friends. The key terms across the domains that appear similar but have different meanings may then be specifically presented to the user 102 as false friends, pointing out the differences in meaning of the key terms to the user 102, as described in greater detail below. This may prevent the user 102 from assuming that the false friends across the domains of information function the same, or have the same meaning in both domains.

The communication logic 220 includes one or more programming instructions for communicating with the user 102 through the interface module 146. For instance, the communication logic 220 may include programming that allows information to be provided to, and received from, the user 102 in the form of a chat bot. For example, when quizzing the user 102 about critical concepts of the new topic to be learned 112, questions may be presented on the visual interface 144 in the form of text, and the user 102 may type responses or otherwise provide selections (e.g. answering a multiple choice question) to the choice options. The communication logic 220 also includes programming that allows information to be provided to, and received from, the user 102 audibly. For instance, when quizzing the user about critical concepts of the new topic to be learned 112, questions may be presented to the user 102 as audial messages through the audial interface 142, and the user 102 may respond to the questions through voice commands and responses through the audial interface 142.

The user 102 may interact with the system 100 visually and audibly simultaneously. For instance, when quizzing the user 102 about critical concepts of the new topic to be learned 112, questions may be presented to the user 102 as text, and the user 102 can respond to the questions through voice command. The communication logic 220 may also include programming that allows the user 102 to provide information to the controller 200 through a camera of the user device 103. For instance, the user 102 may take a photo or video of an item, object, text, or the like, and the topic to be learned logic 210 may include programming to generate a prompt regarding a predicted new topic to be learned 112, such as, “Are you interested in learning about Python?” based on the photo. If the user 102 answers in the affirmative, the system 100 may begin the analysis required to propose questions for the user 102 to explore based on the new topic to be learned 112 and the existing knowledge 110 of the user 102.

The question logic 222 includes one or more programming instructions for generating questions for the user 102 to explore based on the new topic to be learned 112 and the existing knowledge 110 of the user 102. More specifically, based on the model of the existing knowledge 110 of the user 102, the analogies determined between information associated with the new topic to be learned 112 and information associated with the existing knowledge 110 of the user 102, and/or the identified terms associated with the new topic to be learned 112 that appear similar to terms associated with the existing knowledge 110 of the user 102, questions may be generated for the user 102 to explore. The questions are, therefore, particularly tailored to the user 102. That is, the questions proposed to the user 102 do not follow a rigid, linear, or generic curriculum. Instead, the questions may be tailored to allow the user 102 to quickly and efficiently learn the new topic to be learned 112.

More particularly, and merely as an illustrative example, it may be determined that the user 102 has a strong base of existing knowledge 110 in C++. Based on this, there may be no reason to propose questions to the user 102 related to fundamental principles of programming, as the user 102 already knows such basic principles based on the expertise of the user 102 in C++. Rather, questions may be proposed to the user 102 that leverage the existing knowledge 110 of the user 102 to build informational bridges to the new topic to be learned 112. For instance, if while loops are identical in construction and function in C++ and Python, the system 100 may not generate any questions related to while loops in Python, because the user 102 effectively already possesses the requisite knowledge of while loops in Python based on the existing knowledge 110 of the user 102 in C++. In contrast, if there is a difference in the construction of for loops in C++ and Python, a question may be proposed to the user 102 directed toward such difference.

Generally, then, the questions proposed relate to sub-topics of the new topic to be learned 112 that the user 102 does not yet possess a desirable level of knowledge in. The questions proposed may relate to a critical concept shared by the new topic to be learned 112 and the existing knowledge 110 of the user 102. For instance, the questions proposed may relate to loop statements, a critical concept shared by Python and C++. Because Python and C++ share the critical concept, questions may be proposed that build informational bridges between the existing knowledge 110 of the user 102 of the critical concept in C++ and the critical concept in Python, yet to be learned by the user 102.

The questions generated with the question logic 222 function as informational prompts. That is, the questions direct the attention of the user 102 toward one or more sub-topics of the new topic to be learned 112. In presenting these sub-topics in question form, the system 100 may leverage the inquisitiveness of the user 102 to progress the user 102 through the tailored curriculum. That is, the proposed questions may generate more enthusiasm and interest in the user 102 as opposed to mere headings listing different sub-topics the user could select to learn about. However, it should be appreciated that this is a non-limiting example, and in some embodiments, the question logic 222 may include one or more programming instructions for generating informational prompts for the user 102 to explore in any suitable form, such as questions, statements, headings, or the like.

The answer logic 224 includes one or more programming instructions for generating answers to the questions generated with the question logic 222. When the user 102 selects a question to explore, the domain of information associated with the new topic to be learned 112 and the domain of information associated the existing knowledge 110 of the user 102 may be accessed to provide an answer to the user 102. That is, based on the breadth or lack of existing knowledge 110 of the user 102 that can be leveraged to build an informational bridge to the sub-topic of the new topic to be learned 112 associated with the selected question, the system 100 can present as much or as little information, as needed, to answer the selected question. For instance, if the difference between for loops in C++ and Python is a single difference in syntax, when the user 102 selects to explore a question related to for loops in Python, the answer provided may only provide information on the single difference in syntax. This is because the additional rules related to for loops in Python may already be known by the user 102 based on the existing knowledge 110 of the user in C++. In contrast, if for loops in Python are substantially different in syntax and semantics from for loops in C++, the answer provided to a question related to for loops in Python may present a detailed explanation of for loops in Python.

The answers generally leverage the existing knowledge 110 of the user 102 to explain the sub-topic of the new topic to be learned 112 addressed by the question selected by the user 102. For instance, the provided answer may compare or contrast the existing knowledge 110 of the user 102 in sub-topics or core concepts of C++, for instance, with functionally similar sub-topics or shared core concepts of Python, the new topic to be learned 112.

Answers to the selected questions may be presented to the user 102 through the interface module 146 in any suitable form. For instance, the answers may be presented as text, images, video, and/or audial messages. As an example, the answer to a question related to for loops in Python may present explanatory text (i.e. in paragraph form), example Python code, a video tutorial of coding a for loop in Python, or an audial explanation of for loops in Python. It should further be appreciated that the answer may also include a presentation of the existing knowledge 110 of the user 102, for instance, C++ programming. For example, the answer may present a for loop in C++ code and a for loop in Python code side-by-side and point the user 102 to the differences in the programming languages.

The testing logic 226 includes one or more programming instructions for testing the user 102 on the one or more proposed questions explored by the user 102. That is, the system 100 may test the user 102 on the sub-topics of the new topic to be learned 112 that were featured in the question selected by the user 102, and for which an answer was provided to. Testing the user 102 may provide another means to help instill the information provided in the answer to the question explored by the user 102 in the user 102. In other words, the information provided in the answer to the question explored by the user 102 may be reinforced by testing the user 102 on such information. Testing the user 102 may also enable the system 100 to determine if the user 102 has, indeed, learned the sub-topic of the new topic to be learned 112 featured in the question explored, or if the user 102 would benefit from further lessons on the sub-topic. For instance, if after testing, the user 102 does not display a desired knowledge of for loops in Python, additional questions may be presented to the user 102 that relate to the specific aspects of Python for loops that the user 102 did not learn. The user 102 may then select these questions to receive further information on for loops in Python.

The test questions may be presented to the user 102 through the interface module 146 in any suitable form. For instance, the test questions may be short answer questions, multiple choice questions, matching questions, and the like. A short answer format question, for example, may ask the user 102 to draft a for loop in Python. Generally, the test questions may presented to the user 102, and the user 102 may provide answers to the test questions, in a similar fashion as explained above with respect to the questions presented when quizzing the user 102 about critical concepts of the new topic to be learned 112 when building the model of the existing knowledge 110 of the user 102.

The training logic 228 includes one or more programming instructions for utilizing a neural network or other machine learning model to adjust or improve the operation of one or more other logic modules of the memory module 204. For instance, the training logic 228 may include programming to train the analogy logic 216 and/or the term logic 218 to improve the accuracy of the determinations of analogies and/or similar-appearing terms, respectively. The training logic 228 may also include programming for training the existing knowledge logic 212. For instance, the existing knowledge 110 of the user 102 may change over time. The existing knowledge 110 of the user 102 may change as the user 102 consumes and authors new content. That is, the user 102 may gain knowledge in new topics and overarching subjects, and/or the user 102 may gain a greater depth of knowledge in topics and overarching subjects that the user 102 already possessed existing knowledge 110 in. Accordingly, the model of the existing knowledge 110 of the user 102 may be continuously updated over time to incorporate new knowledge gained by the user 102. In embodiments, the model of the existing knowledge 110 of the user 102 may be periodically updated (e.g. every day, every week, and the like).

It is also possible that the user 102 may begin to forget information, or lose knowledge, over time. For instance, the user 102 may learn C++ in college, consuming and authoring a large amount of content in the topic over a period of four years. However, after completing college, the user 102 may not consume or author any new content related to C++ over the next decade. Therefore, the user 102 may forget certain details of the operation of C++ that were once firmly in the existing knowledge 110 of the user 102. Depending on the type of topic or overarching subject in question (e.g. programming language or spoken language), the length of time the user 102 consumed or authored content related to the topic or overarching subject, the density of content consumed or authored by the user 102 within that period of time, the length of time since the user 102 consumed or authored content related to the topic or overarching subject, and like considerations, the model of the existing knowledge 110 of the user 102 may be continuously updated to phase out information from the model of the existing knowledge 110 that the user 102 is predicted to have forgotten.

The model of the existing knowledge 110 of the user 102 may also be updated as the user 102 interacts with the system 100. More specifically, as the user 102 selects questions for the user 102 to explore and reviews the answers to the selected questions, the information and sub-topics explored in the answers may be integrated into the model of the existing knowledge 110 of the user 102. For instance, if the user selects a question related to for loops in Python and accesses an answer to the question containing information on for loops in Python, the information in the answer may be integrated into the model of the existing knowledge 110 of the user 102, as it is assumed that the user 102 has gained the knowledge of the information in the answer. In embodiments, the information in the answer may be integrated into the model of the existing knowledge 110 of the user 102 only after the user 102 has correctly answered one or more testing questions generated with the testing logic 226 and presented with respect to the question selected by the user 102.

Still referring to FIGS. 1 and 2, data storage component 206 may generally be a storage medium. Data storage component 206 may contain one or more data repositories for storing data that is received and/or generated. The data storage component 206 may be any physical storage medium, including, but not limited to, a hard disk drive (HDD), memory, removable storage, and/or the like. While the data storage component 206 is depicted as a local device, it should be understood that the data storage component 206 may be a remote storage device, such as, for example, a server computing device, cloud based storage device, or the like. Illustrative data that may be contained within the data storage component 206 includes, but is not limited to, existing knowledge data, topic to be learned data, analogy data, term data, question data, answer data, testing data, and training data.

The existing knowledge data may generally be data that is used by the controller 200 to build a model of the existing knowledge 110 of the user 102. The topic to be learned data may generally be data that is used by the controller 200 to build a domain of information associated with the new topic to be learned 112. The analogy data may generally be data that is used by the controller 200 to determine analogies between information associated with the new topic to be learned 112 and information associated with the existing knowledge 110 of the user 102. The term data may generally be data that is used by the controller 200 to identify terms associated with the new topic to be learned 112 that appear similar to terms associated with the existing knowledge 110 of the user 102. The question data may generally be data that is used by the controller 200 to propose questions for the user 102 to explore based on the new topic to be learned 112 and the existing knowledge 110 of the user 102. The answer data may generally be data that is used by the controller 200 to provide answers to the questions proposed for the user 102 to explore. The testing data may generally be data that is used by the controller 200 to test the user 102 on one or more proposed questions selected by the user 102 to view an answer to. The training data may generally be data that is generated as a result of one or more machine learning processes used to improve the accuracy of model of the existing knowledge 110 of the user 102, for instance.

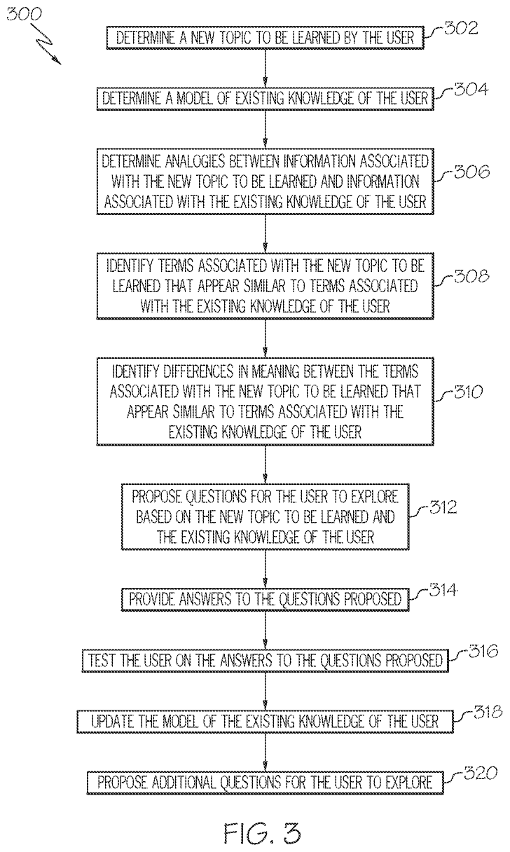

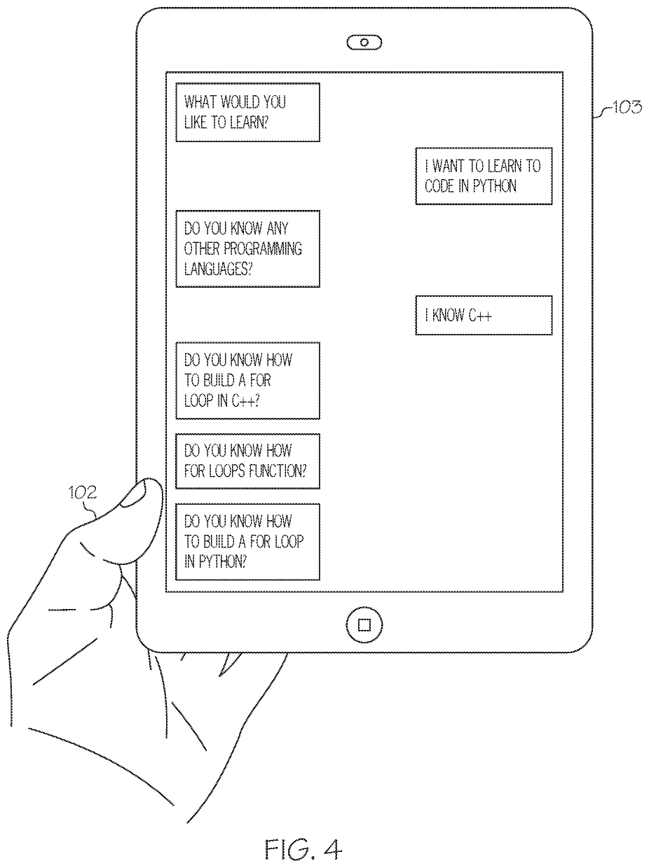

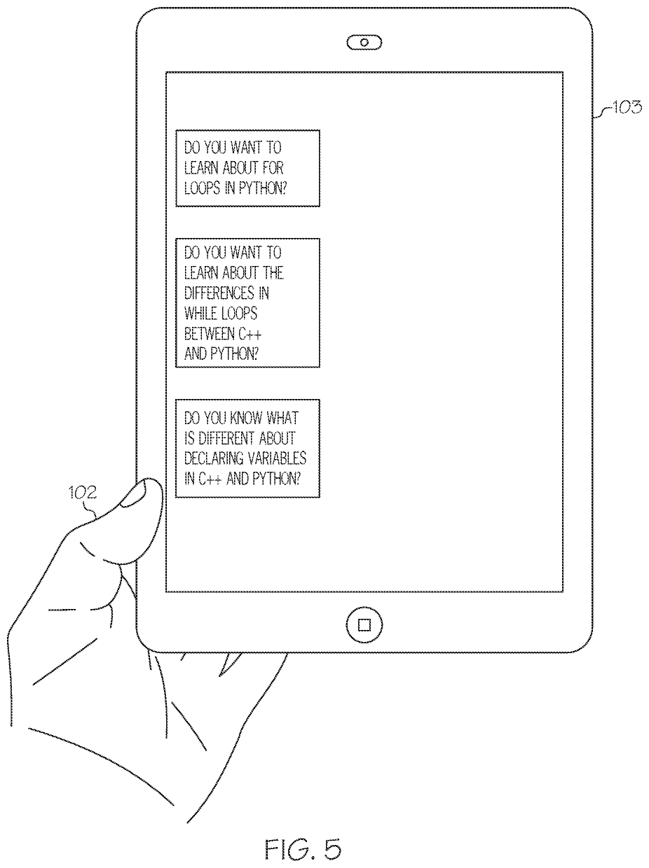

FIG. 3 depicts flowchart for a method 300 for presenting a new topic to be learned. The method 300 may be executed based on instructions stored in the memory module 204 that are executed by the processor 202. FIGS. 4 and 5 schematically depict example user 102 interactions with the user device 103 through the interface module 146 (FIG. 2) according to the method 300 of operation of the system 100.

Referring now to FIGS. 1-4, at block 302 of the method 300, the system 100 determines a new topic to be learned 112 by the user 102. At block 302 the system 100 may receive input from the user 102 indicating the new topic to be learned 112. In some examples, instead of, or in addition to, receiving input from the user 102, the system 100 may predict the new topic to be learned 112 based on user-specific data. With particular reference to FIG. 4, the system 100 may provide the user 102 with a prompt on the user device 103. The user 102 may then type a new topic to be learned 112 into a text box, for instance. More specifically, in the example embodiments depicted in FIG. 4, the user 102 informs the system 100 that the new topic to be learned 112 is the programming language Python.

Referring again to FIGS. 1-4, at block 304 of the method 300, the system 100 determines a model of the existing knowledge 110 of the user 102. At block 304 the system 100 may build the model of the existing knowledge 110 at least in part by quizzing the user 102 about critical concepts of the new topic to be learned 112.

For instance, the system 100 may provide the user 102 with one or more questions related to programming in general. For instance, as depicted in FIG. 4, the system 100 may ask the user 102, “Do you know any other programming languages?” Similarly, the system 100 may ask the user 102, “Do you know how for loops function?” Such questions relate to critical concepts of the new topic to be learned 112, as they relate to the entire genus of programming languages, of which Python, the new topic to be learned 112, belongs.

The system 100 may also provide the user 102 with one or more questions related to the new topic to be learned 112, specifically. For instance, the system 100 may ask the user 102, “Do you know how to build a for loop in Python?” Such a question directly invokes a critical concept of the new topic to be learned 112, Python. Such questions directly involving the new topic to be learned 112 allow the system 100 to account for the extent and depth of existing knowledge 110, if any, the user 102 has that is specific to the new topic to be learned 112 when building the model of the existing knowledge 110 of the user 102. In other words, the system 100 may ask the user 102 about the entire genus that the new topic to be learned 112 belongs to, programming languages, as well as the specific species that the new topic to be learned 112 is, Python.

The system 100 may also provide the user 102 with one or more questions related to a species within the entire genus that the new topic to be learned 112 belongs to that is not the new topic to be learned 112. For instance, the system 100 may ask the user “Do you know how to build a for loop in C++?” Such a question is still related to a critical concept of the new topic to be learned 112. For instance, such a question allows the system 100 to account for the extent and depth of existing knowledge 110, if any, the user 102 has in a topic that can be analogized to the new topic to be learned 112, as will be described in greater detail below. In other words, such a question relates to a critical concept of the new topic to be learned 112 (e.g., for loops), in that it may enable the system 100 to build analogies, or informational bridges, between a sub-topic of the existing knowledge 110 of the user 102 (e.g., for loops in C++) and a sub-topic of the new topic to be learned 112 that the user 102 does not yet possess specific knowledge in (e.g., for loops in Python).

As previously discussed with respect to FIG. 2, the questions proposed to the user 102 when quizzing the user 102 about critical concepts of the new topic to be learned 112 may take any suitable form. For instance, the questions may be multiple choice, matching, short answer, and the like.

In addition to, or instead of, quizzing the user 102 about critical concepts of the new topic to be learned 112, the system 100 may also build the model of the existing knowledge 110 of the user 102 by analyzing content consumed or authored by the user 102. For instance, the system 100 may analyze programs coded in C++ that were written by the user 102 on the user device 103 and/or saved by the user 102 on the user device 103 to determine the existing knowledge 110 of the user in C++ and/or the entire genus of programming.

Still referring to FIGS. 1-4, at block 306 of the method 300, the system 100 determines analogies between information associated with the new topic to be learned 112 and information associated with the existing knowledge 110 of the user 102. For instance, the system 100 may assemble or access a first domain of information associated with the new topic to be learned 112 and a second domain of information associated with the existing knowledge 110 of the user 102, as determined by the model of the existing knowledge 110 of the user 102 determined at block 304. The system 100 may then analyze and compare the domains of information to determine analogies between information associated with the new topic to be learned 112 that is functionally similar to information associated with the existing knowledge 110 of the user 102. For example, the system 100 may determine that the sub-topic of for loops within C++, the existing knowledge 110 of the user 102, function similarly within C++ as the sub-topic of for loops within Python, the new topic to be learned 112, function within Python. In other words, the system 100 may determine that for loops in C++ are analogous to for loops in Python. As explained, by determining analogies between the a first sub-topic of the new topic to be learned 112 and a second sub-topic of the existing knowledge 110 of the user 102, the system 100 may leverage the knowledge of the user 102 in the second sub-topic to present the first sub-topic to the user 102. That is, by comparing or contrasting the first sub-topic with the second sub-topic, the first sub-topic may be easier for the user 102 to learn.

Still referring to FIGS. 1-4, at block 308 of the method 300, the system 100 identifies terms associated with the new topic to be learned 112 that appear similar to terms associated with the existing knowledge 110 of the user 102. That is, by comparing a first domain of information associated with the new topic to be learned 112 and a second domain of information associated with the existing knowledge 110 of the user 102, the system may identify a key term in the first domain that appears similar to a key term in the second domain. The key terms may appear similar by being verbatim matches. The key terms may also appear similar by having the same base or root form.

Still referring to FIGS. 1-4, at block 310 of the method 300, the system 100 identifies differences in meaning between the terms associated with the new topic to be learned 112 and the terms associated with the existing knowledge 110 of the user that appear similar to each other. That is, the system 100 may determine the definitions of the key terms in each domain of information. The system 100 may then determine if a key term associated with the new topic to be learned 112 and a key term associated with the existing knowledge 110 of the user 102, which appear similar, have different meanings within each domain. The system 100 may then specifically present such key terms to the user 102, as explained in greater detail below, to prevent the user from assuming the key terms that appear similar have the same meaning in each domain, when they, in fact, do not.

Referring now to FIGS. 1-5, at block 312 of the method 300, the system 100 proposes questions for the user 102 to explore based on the new topic to be learned 112 and the existing knowledge 110 of the user 102. The proposed questions guide the user 102 through a user-specific curriculum to learn the new topic to be learned 112. The proposed questions generally relate to critical concepts of the new topic to be learned 112. For instance, if the new topic to be learned 112 is Python, the questions proposed may relate to while loops, for loops, and variables.

The system 100 may use the analogies determined between the information associated with the new topic to be learned 112 and the information associated with the existing knowledge 110 of the user 102 to present the new topic to be learned 112 to the user 102 in an efficient and user-friendly manner. For example, the questions proposed may be based on information associated with the new topic to be learned 112 that is functionally similar to information related to the existing knowledge 110 of the user 102. More specifically, if it is determined that for loops function similarly within Python as they do in C++, the system 100 may ask the user 102 questions about for loops in Python that relate (either by comparing or contrasting) for loops in Python with for loops in C++.

Generally, the questions proposed may be based on critical concepts shared by the new topic to be learned 112 and the existing knowledge 110 of the user 102. This may allow the user 102 to grasp critical concepts of the new topic to be learned 112 quicker than if the user 102 was following a generic curriculum assuming the user 102 has no knowledge related to the new topic to be learned 112 whatsoever.

The system 100 may also propose questions to the user 102 based on differences in meaning between the key terms associated with the new topic to be learned 112 and the key terms associated with the existing knowledge 110 of the user 102 that appear similar. More specifically, the system 100 may propose questions to the user 102 based on difference in meaning between the key terms associated with the new topic to be learned 112 and the key terms associated with the existing knowledge 110 of the user 102 that appear similar but have different meanings. For example, the system 100 may ask the user 102 if the user 102 knows, or wants to learn, the difference in meaning between a first key term in Python and a second key term in C++.

As shown in FIG. 5, the proposed questions may be phrased in any desirable manner. They may ask the user 102 if the user wants to learn about a topic or if the user 102 knows a topic already. The new topic to be learned 112 and/or the existing knowledge 110 of the user 102 may be directly referenced in the question wording. By proposing questions to the user 102, the system 100 may better leverage the desire of the user 102 to learn the new topic to be learned 112 to progress the user 102 through the user-specific curriculum. The system 100 may present any number of questions to the user 102 on the user device 103 at a time. The user 102 may select the questions to explore at will. That is, the user 102 can explore the questions in any desirable manner, and the questions need not be explored in a formulaic manner. While the proposed questions allow the user 102 freedom to select a desired sub-topic of the new topic to be learned 112 to be explored first, the system 100 may limit or expand the number or type of questions proposed to the user 102 to ensure the user 102 is not overwhelmed. For instance, the system 100 may first present the user 102 with questions related to basic fundamentals of Python, which the user 102 does not yet know, before presenting the user 102 with questions related to advanced topics that require the user 102 to have mastered the basic fundamentals. As the user 102 explores more questions about Python, the user 102 may “unlock” more advanced questions that the system 100 will then propose for the user to explore, as desired.

Still referring to FIGS. 1-5, at block 314 of the method 300, the system 100 provides answers to the questions proposed. With specific reference to FIG. 5, the user 102 may click on any one of the proposed questions, for instance, to explore the question. In other words, by clicking or otherwise selecting a question, the user 102 is requesting the system 100 provide the user 102 with the answer to the selected question. The answer may appear as a written explanation on the user device 103 that addresses the selected question. As alluded to above, the system 100 may answer the question, therefore explaining a critical concept of the new topic to be learned 112, by referencing (either by comparing or contrasting) the existing knowledge 110 of the user 102. This allows the user 102 to more easily learn about for loops in Python based on the existing knowledge 110 of the user 102 on for loops in C++. As yet another example, it may be easier to learn about specific periods is a first nation's history, such industrial revolutions, civil rights movements, wars, and the like, based on existing knowledge 110 the user 102 possesses on analogous periods in a second nation's history. The system 100 may provide any type of information to answer the selected question. For instance, the system 100 may provide tutorials, example code of Python, and/or representative C++ code to answer the question.

Still referring to FIGS. 1-5, at block 316 of the method 300, the system 100 tests the user on the answers to the questions proposed. The system 100 may test the user 102 by presenting the user 102 with questions, similar to as discussed with reference to block 304. The test questions may be in question form, or may be any prompt requesting input from the user 102. For example, if the user 102 selects to explore the question, “Do you want to learn about for loops in Python?” the system 100 will present an answer to the question, explaining for loops in Python at block 314, and after the user 102 has closed or backed out of the answer provided, the system 100 will present the user 102 with one or more test questions related to for loops in Python. The test questions may reinforce the information provided to the user 102 in the answer. The test questions may also allow the system 100 to determine the extent the user 102 grasped the provided answer, as explained further below.

Still referring to FIGS. 1-5, at block 318 of the method 300, the system 100 updates the model of the existing knowledge 110 of the user 102. The system 100 may update the model of the existing knowledge 110 based on new data available to the system 100. For instance, the system 100 may update the model of the existing knowledge 110 of the user 102 based new content consumed or authored by the user 102. The system 100 may also update the model of the existing knowledge 110 of the user 102 based on the interactions of the user 102 with the previously proposed questions that the user 102 selected to explore, or receive an answer to. For instance, if the user 102 selects the question, “Do you want to learn about for loops in Python?” and reviews the answer to the question, the system 100 may determine that the user 102 now possesses the knowledge presented in the answer. Therefore, the model of the existing knowledge 110 of the user 102 may be updated to include the presented answer on for loops in Python. In embodiments, the system 100 may update the model of the existing knowledge 110 of the user only after the user has explored an answer to a proposed question and correctly answered one or more test questions on the answer explored by the user 102 at block 316. In other words, the system 100 may not assume the user 102 learned the information provided in an answer to a proposed question until the user 102 correctly answers one or more test questions related to the answer.

Still referring to FIGS. 1-5, at block 320 of the method 300, the system 100 proposes additional questions for the user 102 to explore. The additional questions for the user to explore may be based in part on the updated model of the existing knowledge 110 of the user 102, for instance. For instance, if the user 102 explores the question, “Do you want to learn about for loops in Python?” the system 100 may determine that the user 102 now possesses the knowledge presented in the answer to the question. Accordingly, after the user closes or backs out of the answer, the question, “Do you want to learn about for loops in Python?” may no longer be presented on the user device 103. The question may be replaced with any other suitable question for the user 102 to explore. If the system 100 determines, during block 316, for instance, that the user 102 did not learn all of the information provided on for loops in Python, the system 100 may propose questions specifically related to the portions of the provided answer on Python for loops that the user 102 did not retain. The system 100 may also propose more advanced questions on for loops or other Python sub-topics that the user 102 “unlocked” by exploring the earlier question. In this sense, the proposed questions and user-specific curriculum may be fluid and adjust as the user 102 collects more knowledge in certain areas of the new topic to be learned 112.

It should be appreciated that the method 300 discussed above is not limited to the order of steps presented in FIG. 3. For instance, in some embodiments, the analogies between information associated with the new topic to be learned 112 and information associated with the existing knowledge 110 of the user 102 at block 306 may be determined after the identification of terms associated with the new topic to be learned 112 that appear similar to terms associated with the existing knowledge 110 of the user 102 at block 308. It should also be appreciated that steps presented in FIG. 3 need to not be discrete in all embodiments. That is, the system 100 may identify terms associated with the new topic to be learned 112 that appear similar to terms associated with the existing knowledge 110 of the user 102 and identify differences in meaning of such terms substantially simultaneously, such that blocks 308 and 310 may be considered a single step in method 300. Moreover, it should be appreciated that one or more steps of the method 300 depicted in FIG. 3 may be omitted from the method 300. For instance, in some embodiments, the system 100 may not test the user 102 on the answers to the questions proposed at block 314. Additionally, one or more steps not presented in the method 300 depicted in FIG. 3 may be completed by the system 100.

Based on the foregoing, it should now be understood that embodiments shown and described herein relate to systems and methods for presenting a new topic to be learned to a user based on the new topic and existing knowledge of the user. The system collects data on a user to build a model of the existing knowledge of the user. The system also collects data to determine a new topic to be learned by the user.

The system may assemble domains of information related to the existing knowledge of the user and the new topic to be learned by the user to compare. By comparing the existing knowledge of the user with the new topic to be learned, the system may determine analogies between information associated with the new topic to be learned and information associated with the existing knowledge of the user. The analogies may be drawn between information associated with the new topic to be learned that is functionally similar to information associated with the existing knowledge of the user. The system may also identify terms associated with the new topic to be learned and terms associated with the existing knowledge of the user that appear similar but have different meanings.

The system may then propose questions for the user to explore that relate to the new topic to be learned. The questions may relate to a critical concept shared by the new topic to be learned and the existing knowledge of the user. The questions may be based on the analogies drawn between the existing knowledge of the user and the new topic to be learned and/or the key terms of the existing knowledge of the user and the new topic to be learned that appear similar but have different meaning. The system may provide answers to the questions proposed, the answers providing information on the new topic to be learned. The answers may explain the new topic to be learned in light of the existing knowledge of the user, the analogies between the new topic to be learned and the existing knowledge of the user, and/or the identified key terms that appear similar but have different meanings.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

For the purposes of describing and defining the present subject matter, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or function in a particular manner, are structural recitations, as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferable,” “typical,” and “suitable” when utilized herein, are not utilized to limit the scope of the claimed subject matter or to imply that certain features are critical, essential, or even important to the structure or function of the claimed subject matter. Rather, these terms are merely intended to identify particular aspects of an embodiment of the present disclosure or to emphasize alternative or additional features that may or may not be utilized in a particular embodiment of the present disclosure.

For the purposes of describing and defining the present subject matter it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system, comprising a processor configured to:
determine analogies between information associated with a new topic to be learned and information associated with existing knowledge of a user;
identify terms associated with the new topic that appear similar to terms associated with the existing knowledge; and
propose questions for the user to explore based on the new topic and the existing knowledge.

2. The system of claim 1, wherein the processor is further configured to provide answers to the questions proposed.

3. The system of claim 1, wherein the processor is further configured to propose additional questions for the user to explore based on proposed questions explored by the user.

4. The system of claim 1, wherein the processor is further configured to build a model of the existing knowledge of the user by:
analyzing content consumed or authored by the user; or
quizzing the user about critical concepts of the topic to be learned.

5. The system of claim 4, wherein the processor is further configured to update the model of the existing knowledge of the user based on proposed questions explored by the user.

6. The system of claim 1, wherein the analogies comprise information related to the new topic that is functionally similar to information related to the existing knowledge.

7. The system of claim 1, wherein the processor is further configured to identify differences in meaning between the terms associated with the new topic that appear similar to terms associated with the existing knowledge.

8. The system of claim 1, wherein questions proposed relate to a critical concept shared by the topic to be learned and the existing knowledge.

9. The system of claim 1, wherein questions proposed are based on information associated with the new topic that is functionally similar to information associated with the existing knowledge.

10. The system of claim 1, wherein questions proposed are based on differences in meaning between the terms associated with the new topic that appear similar to terms associated with the existing knowledge.

11. A method implemented by a processor of a device, the method comprising:
determining analogies between information associated with a new topic to be learned and information associated with existing knowledge of a user;
identifying terms associated with the new topic that appear similar to terms associated with the existing knowledge; and
proposing questions for the user to explore based on the new topic and the existing knowledge.

12. The method of claim 11, further comprising providing answers to the questions proposed.

13. The method of claim 11, further comprising building a model of the existing knowledge of the user by:
analyzing content consumed or authored by the user; or
quizzing the user about critical concepts of the topic to be learned.

14. The method of claim 11, wherein the analogies comprise information associated with the new topic that is functionally similar to information associated with the existing knowledge.

15. The method of claim 11, further comprising identifying differences in meaning between the terms associated with the new topic that appear similar to terms associated with the existing knowledge.

16. A processor of a computing device, the processor configured to:
determine analogies between information associated with a new topic to be learned and information associated with existing knowledge of a user;
identify terms associated with the new topic that appear similar to terms associated with the existing knowledge; and
propose questions for the user to explore based on the new topic and the existing knowledge.

17. The processor of claim 16, further configured to provide answers to the questions proposed.

18. The processor of claim 16, further configured to build a model of the existing knowledge of the user by:
analyzing content consumed or authored by the user; or
quizzing the user about critical concepts of the topic to be learned.

19. The processor of claim 16, wherein the analogies comprise information associated with the new topic that is functionally similar to information associated with the existing knowledge.

20. The processor of claim 16, further configured to identify differences in meaning between the terms associated with the new topic that appear similar to terms associated with the existing knowledge.
